(19) United States
(12) Patent Application Publication
(10) Pub. No.: US 2009/0094609 A1
(43) Pub. Date: Apr. 9, 2009

(54) DYNAMICALLY PROVIDING A LOCALIZED USER INTERFACE LANGUAGE RESOURCE

(75) Inventors: Anatoliy Burukhin, Issaquah, WA (US); Makarand Atulchandra Gadre, Redmond, WA (US); Ayman M. Aldahleh, Redmond, WA (US); Terry Farrell, Mount Merrion (IE); Javier Luis Larrinaga-Pardo, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/869,083

(22) Filed: Oct. 9, 2007

(51) Int. Cl. G06F 9/46

(52) U.S. Cl. 718/104

(57) ABSTRACT

Technologies are described herein for dynamically providing a localized user interface (“UI”) resource. A localization framework includes a resource manager, resource sets, and resource readers. The resource manager exposes an application programming interface (“API”) to application programs for requesting a localized UI resource from the resource manager. When the resource manager receives a request for a localized UI resource on the API, the resource manager queries the resource sets for the requested resource. If the first resource set is unable to provide the requested localized UI resource, another resource set may be queried. Multiple resource readers within each resource set may also be configured to provide flexibility in how UI resources are loaded and processed.

### BACKGROUND

Computer software localization refers to the process of creating user interface (“UI”) resources that are adapted to a local language and culture. Localization often includes the labor-intensive process of translating UI resources from a source language to a destination language. For instance, a common example of localization occurs when the text strings utilized by an application program are first authored in a source language, such as English. In order to market the application program in another country, it is often necessary to translate the English language text strings to the destination language. Localization may also include modifying UI resources to account for other cultural differences, such as right-to-left languages, gender or age considerations, and others.

The localization of an application program is generally complex, manual, and detached from the mainstream development of the application. For instance, in many cases all or a large portion of the UI resources for an application program are first created in a source language. The UI resources are then provided to a translator for manual translation into one or more destination languages. Because the localization process is generally performed separately from the mainstream development of the application program, it can often be difficult to introduce changes to the UI resources that might ease their translation. Moreover, because the localization process is often performed after the bulk of the application development work has concluded, the localization process can impose a significant time delay before the application program can be brought to market.

The localization of an application program is also generally disconnected from the runtime of an application program. For instance, most application programs load and cache localized UI resources at execution time. The application program then utilizes the cached UI resources during the execution lifetime of the application program. As a result, in order to change the UI language utilized by the application program, a user must often close the application program, choose a new UI language, and restart the application program. This can be time consuming and frustrating for multi-lingual users that need to utilize application programs in a variety of languages.

It is with respect to these considerations and others that the disclosure made herein is presented.

### SUMMARY

Technologies are described herein for dynamically providing a localized UI resource. In particular, a localization framework is provided herein for accessing, manipulating, and managing localized UI resources. Through the use of the framework, localized UI resources can be verified, translated, pseudo-localized, or processed in other ways at runtime. This type of functionality allows the localization process to be more tightly integrated with application development. This functionality also allows a new UI language to be selected and utilized without restarting an application program.

According to one aspect presented herein, a localization framework is disclosed that dynamically provides localized UI resources. In one embodiment, the localization framework includes a resource manager. The resource manager exposes an application programming interface (“API”) to application programs. The application programs use the API to request localized UI resources from the resource manager. As used herein, the term localized UI resource generally refers to UI text strings that are customized for a particular locality and/or culture. It should be appreciated, however, that a localized UI resource might comprise another type of software object that has been customized for a particular locality and/or culture. It should also be appreciated that the aspects presented herein are not limited to use with localized UI resources. Rather, the embodiments presented herein may be utilized with any type of resource utilized by an application program, regardless of whether the application program has been localized or not.

According to other aspects, the localization framework also includes one or more resource sets that operate in conjunction with the resource manager. The resource sets are collections of resource readers. Resource readers are software components that are capable of reading and processing resources. For instance, resource readers may be configured to read a resource such as a localized UI resource from a dynamically linked library (“DLL”), from a database, from a network location, or from another type of source or location. Resource readers can also perform other operations on resources, including machine language translation, pseudo-localization, and others.

According to other aspects, multiple resource sets may be configured for use with the resource manager. When the resource manager receives a request for a localized UI resource on the API, the resource manager queries a resource set for the resource. If the queried resource set is unable to provide the requested localized UI resource, another resource set may be queried. This process continues until the requested localized UI resource has been located or all of the resource sets have been queried without success. According to embodiments, each resource set may be able to provide a subset of the entire requested localized UI resource until the entire requested localized UI resource has been obtained.

The resource readers within each resource set may also be configured to provide flexibility in how UI resources are loaded and processed. For instance, in one embodiment multiple resource readers may be chained for sequential execution. This provides each resource reader an opportunity to load or modify a UI resource prior to returning the UI resource to the requesting application. Chained resource readers may be executed sequentially until each of resource readers has been executed or one of the resource readers explicitly terminates the execution chain. According to other aspects, the localization framework also includes a resource monitor configured to monitor the operation of the resource manager, the resource sets, and the resource readers.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram illustrating aspects of a software architecture presented herein in one embodiment capable of dynamically providing a localized UI language resource;

FIG. 2 is a software architecture diagram illustrating additional aspects of a localization framework provided herein in one embodiment capable of dynamically providing a localized UI language resource;

FIG. 3 is a software architecture diagram showing additional aspects of the operation of a resource manager and several resource sets presented herein in one embodiment;

FIGS. 4 and 5A-5E are software architecture diagrams showing additional aspects regarding the configuration and operation of one or more resource readers provided in embodiments presented herein;

FIG. 6 is a flow diagram showing a routine provided herein in one embodiment for dynamically providing a localized UI language resource; and

FIG. 7 is a computer architecture diagram showing an illustrative computer hardware and software architecture for a computing system capable of implementing the embodiments presented herein.

### DETAILED DESCRIPTION

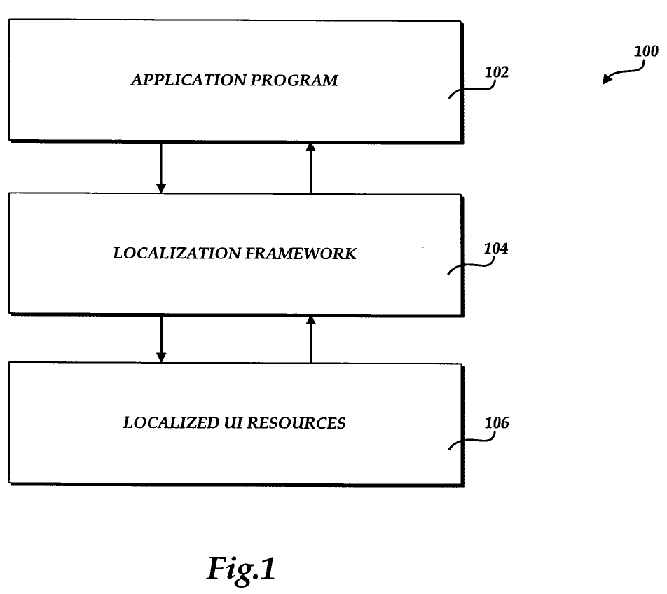

The following detailed description is directed to technologies for dynamically providing a localized UI resource. Through the utilization of the technologies and concepts presented herein, a localization framework is provided that utilizes pluggable and configurable resource readers to dynamically read and modify localized UI resources. Through the use of the localization framework described herein, greater flexibility is provided for loading and utilizing localized UI resources than provided in previous localization solutions. Additional details regarding the various embodiments presented herein for dynamically providing a localized UI resource will be provided below with reference to FIGS. 1-7.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for dynamically providing localized UI resources will be provided. In particular, FIG. 1 illustrates a software architecture 100 described herein for dynamically providing a localized UI language resource. The software architecture 100 shown in FIG. 1 includes a localization framework 104. As discussed in greater detail herein, the localization framework 104 exposes an API for use by an application program 102 to retrieve localized UI resources 106. As discussed briefly above, the term localized UI resource generally refers to UI text strings that are customized for a particular locality and/or culture. Other types of software objects that have been customized for particular locality and/or culture may also be retrieved in a similar fashion through the localization framework 104 provided herein.

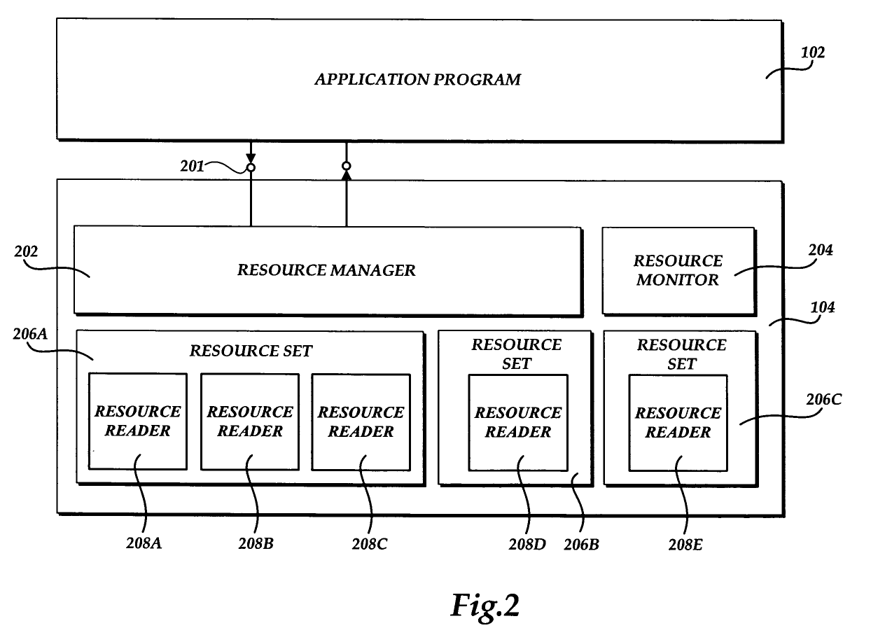

As will be discussed in greater detail herein, the localization framework 104 comprises a flexible software system for accessing, manipulating, and managing the localized UI resources 106. The localization framework 104 can access multiple resource formats, resources stored in databases, and resources stored in remote or network locations. The localization framework 104 is also capable of operating with localized UI resources stored in a DLL runtime format or directly with authoring or localization resources 106 stored in an extensible markup language (“XML”) format in a localization database. The localization framework 104 also permits controlling and post-processing localized UI resources 106. For instance, localized UI resources 106 can be verified, translated, pseudo-localized, or processed in other ways at runtime. The localization framework 104 also permits collecting information on the use of the localized UI resources 106 by the application program 102. Additional details regarding this functionality is provided in greater detail below with respect to FIGS. 2-7.

Referring now to FIG. 2, additional details regarding a localization framework 104 provided in embodiments will be described. As shown in FIG. 2, the localization framework 104 includes a resource manager 202. The resource manager 202 exposes an API 201 to an application program 102, or to another type of computer program such as an operating system. Through the API 201, the application program 102 can request localized UI resources 106. In one implementation, the API 201 is a unified API that provides a unified feature set that is independent of the type of resource sets 206A-206C and resource formats that are utilized. The API 201 may utilize a resource identifier, a resource string, or another type of identifier as a key to looking up a particular resource.

In order to respond to requests received on the API 201, the resource manager 202 utilizes one or more resource sets 206A-206C. In one embodiment, each of the resource sets 206A-206C corresponds to a resource database that stores the resources localized for one particular culture. It should be appreciated, however, that the resource sets 206A-206C may correspond to other types of resources, locations of resources, or configurations of resources.

In one implementation provided herein, the resource sets 206A-206C do not maintain information about the structure of the localized UI resources 106. Rather, the low level operations of reading the localized UI resources 106 are performed by the resource readers 208A-208E. Each of the resource sets 206A-206C may include one or more resource readers 208. For instance, the resource set 206A includes the resource readers 208A-208C, the resource set 206B includes the resource reader 208D, and the resource set 206C includes the resource reader 208E.

Each of the resource readers 208A-208E is configured to either read a localized UI resource 106 or perform another type of operation on a previously read localized UI resource 106. For instance, the resource readers 208A-208E may be configured to perform a machine language translation of a previously read localized UI resource 106, perform pseudo-localization, or perform another type of function. The resource readers 208A-208E may also be capable of repairing a resource to remove any errors from a resource, such as errors that might impact an application program visually or functionally.

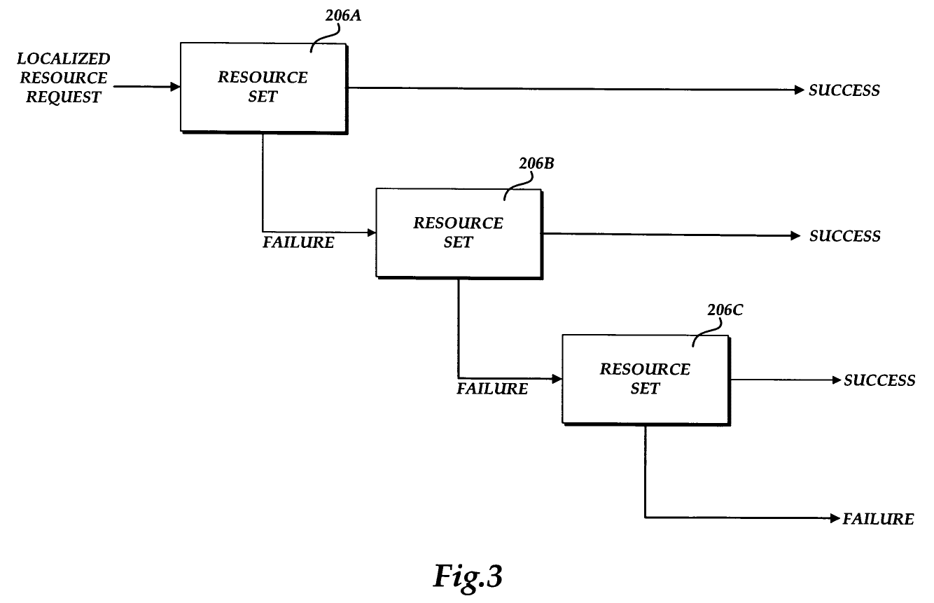

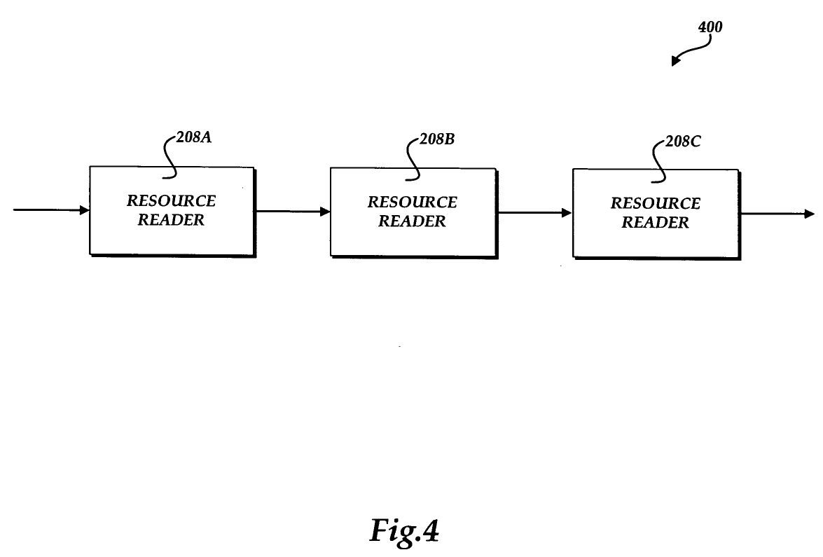

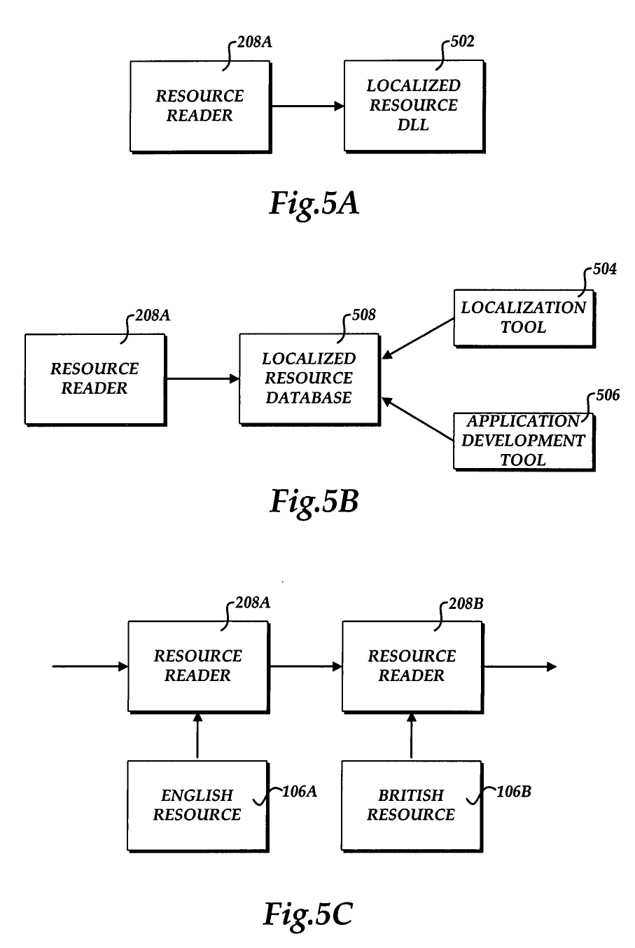

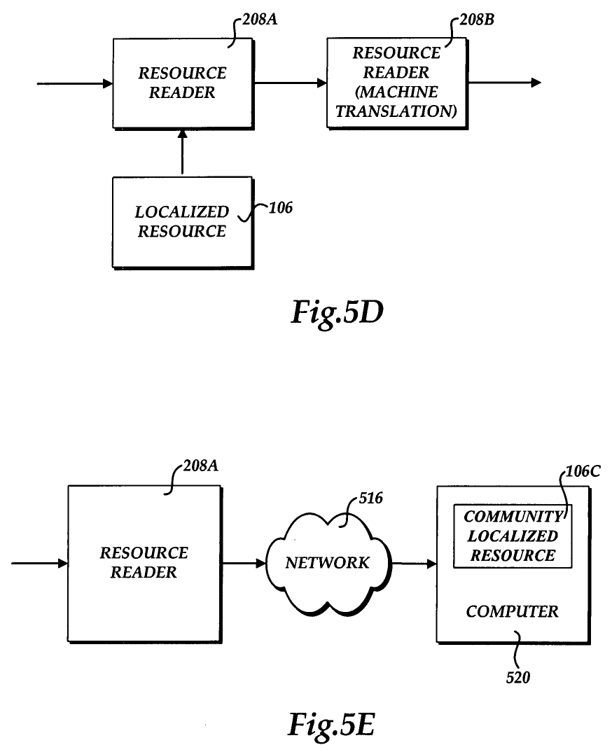

As will be described in greater detail below, the resource readers 208 within a particular resource set 206 may also be chained or otherwise linked to execute in parallel or sequentially. Data read by one of the resource readers may be provided to another resource reader for processing. In this manner, each of the resource readers within a resource set may be provided an opportunity to modify a resource. The framework 104 also allows the resource readers 208A-208E to be plugged therein. Additional details regarding the operation of the resource manager 202 with regard to selecting an appropriate resource set 206 will be provided below with respect to FIG. 3. Additional details regarding the configuration and operation of the resource readers 208A-208E will be provided below with respect to FIGS. 4 and 5A-5E.

According to other embodiments, the API 201, resource sets 206A-206C, and the resource readers 208A-208E are configured to permit the concurrent loading of multiple localized UI resources in different languages. For instance, in such a configuration it is possible to display the user interface provided by the application program 102 in one language while displaying other aspects, such as tool tips, in another language. In this manner, different languages may be concurrently utilized for different aspects of the output of the application program 102.

As also illustrated in FIG. 2, the localization framework 104 may include a resource monitor 204. The resource monitor 204 is a software component configured to maintain information about the presence and operation of the other objects within the localization framework 104. The resource monitor 204 may also provide functionality for managing the operation of the resource manager 202, the resource sets 206, and the resource readers 208. In one embodiment, each of the resource readers 208A-208E register with the resource monitor 204. This enables the resource monitor 204 to create instances of the resource readers 208A-208E.

According to one implementation provided herein, the resource manager 202, resource sets 206A-206C, and the resource monitor 204 do not modify the localized UI resources 106. Moreover, these objects do not maintain knowledge about localized UI resource identifiers or the nature of the data read by the resource readers 208A-208E. Instead, the resource readers 208A-208E are responsible for organizing resource identifiers and filling in the appropriate resource data in response to requests received from the application program 102 on the API 201. It should further be appreciated that, according to embodiments, no memory allocation occurs within the localization framework 104 during the transition of localized UI resources 106 from a resource reader 208 to the application program 102. Therefore, the performance overhead of the resource manager 202 and the resource sets 206A-206C is minimal. According to implementations, where performance is particularly crucial the application program 102 may be permitted to access localized UI resources 106 directly from the resource readers 208A-208E, thereby bypassing the other layers of the localization framework 104.

Referring now to FIG. 3, additional details will be provided regarding the use of the resource sets 206A-206C by the resource manager 202. According to one implementation provided herein, the resource manager 202 may receive a request for a localized UI resource 106 from the application program 102. In response to such a request, the resource manager 202 may first request the resource from a resource set 206A. If the resource set 206A is able to provide the requested resource, the resource manager 202 provides the returned resource to the application program 102. If, however, the resource set 206A returns a failure indication to the resource manager 202, the resource manager 202 may then request the same localized UI resource 106 from the resource set 206D.

If the resource set 206B successfully returns the requested resource, the resource manager 202 will return the resource to the application program 102. If, however, the resource set 206B indicates that the requested localized UI resource 106 could not be located, the resource manager 202 may then transmit a request to the resource set 206C for the requested resource. If the resource set 206B is able to identify the requested localized UI resource 106, it is returned to the application program 102 by the resource manager 202. Otherwise, a failure message may be returned to the application program 102 indicating that none of the resource sets 206A-206C were able to locate the identified localized UI resource 106. In this manner, the resource manager 202 can query multiple resource sets 206A-206C for the requested localized UI resource 106. It should be appreciated that the order in which the resource sets 206A-206C are queried may be defined such that the first resource set 206A that is queried by the resource manager 202 provides the requested localized UI resource 106 from a preferred location. Subsequent resource sets 206B-206C may be considered fallbacks in the event that the resource set 206A is unable to provide the requested resource.

Referring now to FIG. 4, additional details will be provided regarding the configuration and use of the resource readers 208A-208E. As shown in FIG. 4, the resource readers within a particular resource set may be chained consecutively for execution. For instance, in the example shown in FIG. 4, the resource reader 208A is chained with the resource readers 208B and 208C. During execution, the resource reader 208A will first obtain a localized UI resource 106. The resource 208A will then provide the obtained resource to the resource reader 208B. The resource reader 208B may then perform other types of processing on the resource, such as a machine language translation. The resource reader 208B may then explicitly terminate the execution chain or pass the results of its processing on to the resource reader 208C for additional processing. It should be appreciated that any number of resource readers 208 may be chained for execution in the manner illustrated in FIG. 4. It should be appreciated also that, in other embodiments, the resource readers may be configured for execution in a manner other than sequentially. For instance, the resource readers 208A may be executed in parallel or in another fashion.

Referring now to FIGS. 5A-5E, additional details regarding the configuration of and functionality provided by the resources readers 208A-108E will be presented. In particular, FIG. 5A illustrates a resource reader 208A that is configured to read a localized UI resource 106 from a DLL 502. In this manner, the resource reader 208A can read localized UI resources 106 stored in binary runtime formats utilized previously by many types of application programs. In other embodiments, the resource reader 208A is configured to read localized UI resources 106 from a resource database 508. This is illustrated in FIG. 5B. In this embodiment, the resource database 508 stores localized UI resources 106 that are expressed using XML or another type of standard markup format.

In the embodiment shown in FIG. 5B, a localization tool 504 may be utilized by translators to update the contents of the localized resource database 508. Similarly, an application development tool 506 may be utilized by application developers to update the contents of the resource database 508. Because the framework 104 utilizes the resource reader 208A to retrieve localized UI resources 106 at runtime, changes made utilizing the localization tool 504 or the application tool 506 can be made available immediately in the application program 102 without performing a rebuild. In this way, the localization process can be more tightly integrated within the application development process. Because the resource reader 208A retrieves the requested localized UI resources 106 from the resource database 508 dynamically, it is unnecessary for the application program 102 to be recompiled or even restarted in order to make changes to the user interface language presented by the application program 102.

It should be appreciated that, according to embodiments, the particular resource that is utilized may be different depending on the point in the development lifecycle of the application program 102. For instance, resources contained in XML files may be utilized during development while built files may be shipped with the completed application. Similarly, different resources may even be utilized at runtime. For instance, remotely located resources may be utilized if the application program 102 is online and connected to a network. If the application program 102 is offline, locally stored resources may be utilized.

FIG. 5C illustrates another configuration of the resource readers 208 provided herein. In the example shown in FIG. 5C, the resource reader 208A has been chained for execution with the resource reader 208B. In this example, the resource reader 208A is configured to read an English language resource 106A. Once the English language resource 106A has been read, the English language resource 106A is provided to the resource reader 208B.

The resource reader 208B examines the American English language resource 106A and determines whether any words contained therein need to be modified with a British English language equivalent. The resource reader 208B performs this functionality by consulting a British English language resource 106B that identifies the British English language construction for various words. For instance, the British English language resource 106B may indicate that the American English language word “color” should be replaced with the British English language equivalent, “colour.” The modified American English language resource 106A is then provided to the resource manager 202. In this way, a resource reader 208B can modify a resource read by another resource reader 208A.

FIG. 5D illustrates a configuration of the resource readers 208 wherein one resource reader 208B performs a machine language translation of a localized resource 106 that has been read by another resource reader 208A. In this example, the resource reader 208A reads a requested localized UI resource 106 and passes the resource 106 to the resource reader 208B. The resource reader 208B is operative to perform a machine language translation of the localized resource 106 and provide the translated resource to the resource manager 202. Translation performed by the resource reader 208 may be performed on-the-fly and in a manner that is essentially transparent to a user of the application program 102. In this manner, localized UI resources 106 can be read and translated at runtime in response to requests from an application program 102 for the localized UI resource 106.

Referring now to FIG. 5E, another implementation will be described wherein a resource reader 208A is operative to read a localized UI resource 106 from a network location. In this example, the resource reader 208A is configured to communicate with a computer 520 via a network 516. The network 516 may comprise a local area network (“LAN”) or a wide area network (“WAN”), such as the Internet. In this example, a localized UI resource 106C is maintained at the computer 520 and updated by a community of users. Through the community interaction, the localized resource 106C may be created for an infrequently used or requested language or culture.

In response to requests from the application program 102 at runtime, the resource reader 208A may communicate with the computer 520 to retrieve the localized resource 106C over the network 516 from a network location or Web service. By obtaining localized resources over the network 516, this type of configuration enables the application program 102 to be shipped without support for all possible applications. The appropriate resources for supporting various languages may be obtained over the network 516 from a computer 520 at runtime. This type of configuration may also be utilized to update localized UI resources 106 that are included with the application program 102 at the time it is initially shipped. This allows the gradual localization of the application program 102. In this type of scenario, the application program 102 may be shipped with limited localization. The localization of the application program 102 may then be gradually upgraded through the use of resources available from a network, such as community-created resources. This eliminates the previous problem of having to wait to ship an application program until the application program has been completed localized for all language.

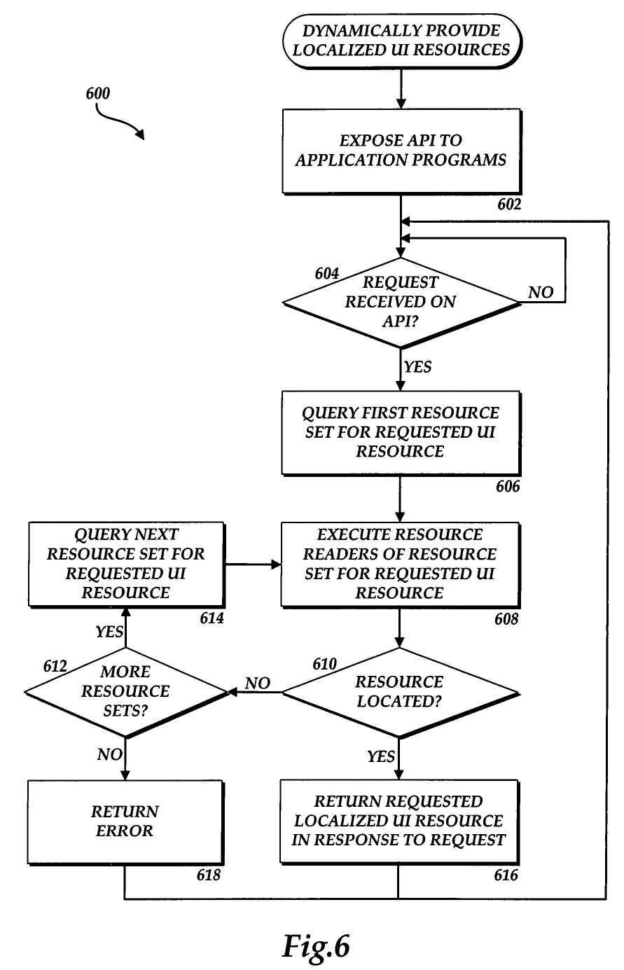

Referring now to FIG. 6, additional details will be provided regarding the embodiments presented herein for dynamically providing a localized user interface language resource. In particular, FIG. 6 shows a flow diagram describing a routine 600 for dynamically providing a localized user interface resource. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 600 begins at operation 602, where the localization framework 104 exposes the API 201 to the application program 102. The resource manager 202 then determines at operation 604, whether a request was received on the API 201 for a localized UI resource 106. If no request has been received, the routine 600 returns to operation 604. If, however, the resource manager 202 detects a request at the API 201 for a localized UI resource 106, the routine 600 continues from operation 604 to operation 606.

At operation 606, the resource manager 202 queries the resource set 206A for the requested localized UI resource 106. In response to the query, the resource set 206A executes the resource readers 208A-208C in an attempt to locate the requested UI resource 106. If the resource set 206A is able to locate the requested localized UI resource 106, it is returned to the resource manager 202 at operation 616. If the resource set 206A is unable to locate the requested localized UI resource 106, the routine 600 branches from operation 610 to operation 612.

At operation 612, the resource manager 202 determines whether any other resource sets 206 need to be queried for the requested localized resource 106. If additional resource sets 206 remain to be queried, the routine 600 proceeds from operation 612 to operation 614. At operation 614, the resource manager 202 queries the next resource set 206B for the requested localized UI resource 106. From operation 614, the routine 600 returns to operation 608 where the resource reader 208D of the queried resource set 206B are executed in an attempt to locate the requested localized UI resource 106.

If, at operation 612, the resource manager 202 determines that no other resource sets 206 remain to be queried, the routine 600 proceeds to operation 618, where the resource manager 202 returns an error to the application program 102 indicating that the requested localized UI resource 106 could not be located. From operations 616 and 618, the routine 600 returns to operation 604, described above, where the resource manager 202 determines if a request for a localized UI resource 106 has been received at the API 201.

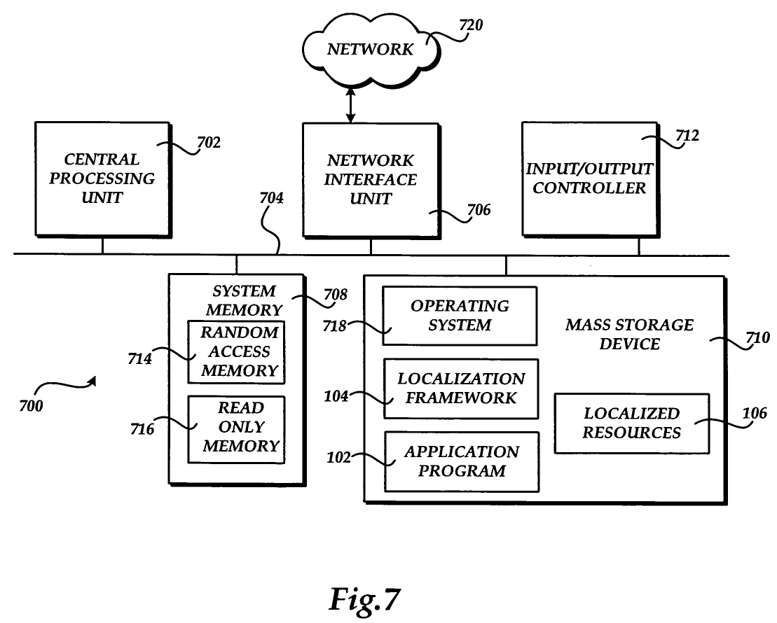

FIG. 7 shows an illustrative computer architecture for a computer 700 capable of executing the software components described herein for dynamically providing a localized user interface language resource. The computer architecture shown in FIG. 7 illustrates a conventional desktop, laptop, or server computer capable of executing some or all of the software components described herein.

The computer architecture shown in FIG. 7 includes a central processing unit 702 (“CPU”), a system memory 708, including a random access memory 714 (“RAM”) and a read-only memory (“ROM”) 716, and a system bus 704 that couples the memory to the CPU 702. A basic input/output system containing the basic routines that help to transfer information between elements within the computer 700, such as during startup, is stored in the ROM 716. The computer 700 further includes a mass storage device 710 for storing an operating system 718, application programs, and other program modules, which are described in greater detail herein.

The mass storage device 710 is connected to the CPU 702 through a mass storage controller (not shown) connected to the bus 704. The mass storage device 710 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available computer storage media that can be accessed by the computer 700.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 720. The computer 700 may connect to the network 720 through a network interface unit 706 connected to the bus 704. It should be appreciated that the network interface unit 706 may also be utilized to connect to other types of networks and remote computer systems. The computer 700 may also include an input/output controller 712 for receiving and processing input from a number of other devices, including a keyboard, mouse, or electronic stylus (not shown in FIG. 7). Similarly, an input/output controller may provide output to a display screen, a printer, or other type of output device (also not shown in FIG. 7).

As mentioned briefly above, a number of program modules and data files may be stored in the mass storage device 710 and RAM 714 of the computer 700, including an operating system 718 suitable for controlling the operation of a networked desktop, laptop, or server computer. The mass storage device 710 and RAM 714 may also store one or more program modules. In particular, the mass storage device 710 and the RAM 714 may store the application program 102, localization framework 104, and the localized resources 106, each of which has been described above. The mass storage device 710 and the RAM 714 may also store other program modules.

Based on the foregoing, it should be appreciated that technologies for dynamically providing a localized user interface resource are disclosed herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments illustrated and described, and without departing from the spirit and scope of the present invention, which is set forth in the following claims.

What is claimed is:

1. A method for dynamically providing a resource, the method comprising:
receiving a request for the resource;
in response to the request, requesting the resource from a first resource set comprising one or more pluggable resource readers;
receiving the resource from the first resource set; and
returning the requested resource in response to the request.

2. The method of claim 1, further comprising:
receiving an indication from the first resource set indicating that the requested resource could not be located; and
in response to receiving the indication, requesting the resource from a second resource set, the second resource set comprising one or more pluggable resource readers.

3. The method of claim 1, wherein the two or more resource readers of the first resource set are chained for sequential execution.

4. The method of claim 1, wherein one of the resource readers of the first resource set is configured to read the requested resource from a dynamically linked library.

5. The method of claim 1, wherein one of the resource readers of the first resource set is configured to read the requested resource from a localized resource database.

6. The method of claim 1, wherein one of the resource readers of the first resource set is configured to read the requested resource from a web service.

7. The method of claim 1, wherein one of the resource readers of the first resource set is configured to perform a machine language translation of the requested resource.

8. The method of claim 1, wherein a first one of the resource readers of the first resource set is configured to modify a resource provided by a second one of the resource readers of the first resource set.

9. A system for dynamically providing a user interface resource, the system comprising:
a resource manager configured to expose an application programming interface (API) to one or more application programs, to receive a request on the API from one of the application programs for a user interface resource, and to request the user interface resource from a resource set in response thereto;
a first resource set comprising one or more resource readers and configured to receive and respond to the request from the resource manager for the user interface resource; and
one or more resource readers, each of the resource readers associated with the first resource set and operative to receive and respond to the request from the resource manager for the user interface resource.

10. The system of claim 9, further comprising a resource monitor configured to monitor the operation of the resource manager and the one or more resource readers of the first resource set.

11. The system of claim 9, wherein the first resource set is further configured to provide an indication to the resource manager if the user interface resource cannot be located, and wherein the resource manager is further configured to request the user interface resource from a second resource set in response to receiving the indication from the first resource set.

12. The system of claim 9, wherein two or more of the resource readers of the first resource set are chained for sequential execution.

13. The system of claim 9, wherein one of the resource readers of the first resource set is configured to retrieve the requested user interface resource from a dynamically linked library.

14. The system of claim 9, wherein one of the resource readers of the first resource set is configured to read the user interface resource from a localized resource database.

15. The system of claim 9, wherein one of the resource readers of the first resource set is configured to read the user interface resource from a web service.

16. The system of claim 9, wherein one of the resource readers of the first resource set is configured to perform a machine language translation of the user interface resource.

17. The system of claim 9, wherein a first one of the resource readers of the first resource set is configured to modify a user interface resource provided by a second one of the resource readers of the first resource set.

18. A computer-readable medium having computer-executable instructions stored thereon which, when executed by a computer, cause the computer to:
expose an application programming interface (API) to one or more application programs for obtaining localized user interface resources;
to receive a request on the API from one of the application programs for a localized user interface resource; and to
query a resource set having one or more resource readers for the localized user interface resource in response to receiving the request.

19. The computer-readable medium of claim 18, wherein two or more of the resource readers of the resource set are chained for sequential execution.

20. The computer-readable medium of claim 19, wherein one of the resource readers of the resource set is configured to read the requested localized user interface resource from a network location.
